(19) United States
(12) Patent Application Publication
(10) Pub. No.: US 2010/0306673 A1
(43) Pub. Date: Dec. 2, 2010

(54) METHOD AND DEVICE FOR ACCESSING DATA IN SIGNAGE SYSTEMS

(75) Inventor: Avishay Ben Natan, Rishon LeZion (IL)

Correspondence Address: BROWDY AND NEIMARK, P.L.L.C.;624 NINTH STREET, NW, SUITE 300, WASHINGTON, DC, 20001-5303, US

(73) Assignee: C-NARIO Ltd., Tel-Aviv (IL)

(21) Appl. No.: 12/599,983

(22) PCT Filed: May 12, 2008
(86) PCT No.: PCT/IL08/00658

§ 371 Date: Nov. 13, 2009

(30) Foreign Application Priority Data
May 13, 2007 (IL) 188,148

(51) Int. Cl. G06F 3/00

(52) U.S. Cl. 715/753

(57) ABSTRACT

A method is provided for displaying information at remote terminals, based on criteria established at a central terminal. At the central terminal, a set of rules is selected out of a plurality of pre-defined sets of rules for displaying the information at the respective remote terminal, and based on the selected set of rules, a virtual tokens is created, which is then forwarded to the respective remote terminal. The token is received at the remote terminal, and the identification of the corresponding set of rules is derived. Based on the identified set(s) of rules, one or more corresponding software modules operative to retrieve information originated at additional source(s) is uploaded for use at the respective remote terminal. Next, a display of information that comprises information retrieved by using the corresponding software modules is generated and presented at the remote terminal.

### FIELD OF THE INVENTION

The present invention relates to signage systems. Particularly, it concerns methods and devices for accessing alien data sources in signage systems.

### BACKGROUND OF THE INVENTION

Digital signage systems are used to display information in public places. In most installations, data is sent from one or more different locations and stored on a local player non-volatile storage, such as disk, to be played according to a predefined schedule.

In some implementations of digital signage, full screen video is displayed, in other implementations, the screen is divided into zones and different content is displayed at each zone. By a popular implementation of the zones approach, ads are placed into the main zone while useful information is placed in other zones. Weather information, news, stock information, transportation information are examples of information often displayed in these zones.

Such information mostly resides in other systems data storage means. These data storage means can be web services, web pages, remote or local databases, Rich Site Summary (referred to hereinafter as “RSS”) feeds and the like.

In order to avoid tedious manual labor in copying data from sources into the digital signage system, numerous approaches were developed to facilitate automatic data updates.

The following approaches for automatic data access in digital signage applications are known in the art:
Built in support within an application used for accessing various data sources.
   By this approach, the application is built to access data sources, and is typically used in any one of the following cases: to support reading a text file which can periodically be changed by a different application running at the player, providing support for RSS access which is given a URL as a parameter and displays selected pieces of information, support for database access where the user defines the connection information with the remote database, required tables, views or stored procedures.
   FIG. 1 is a screenshot of a built in database access of a typical signage application, used in prior art systems. At the center, the network administrator (the user) defines various access pre-defined parameters. The player workstation accesses the database using the predefined parameters, and new information that would be stored at the database, is automatically reflected on the connected players.
Using scripts to access information available on different external data sources.
   Scripts are written to access remote data storage means. A script can be used to access a web page, to find specific HTML tags on the retrieved page, to format the text or images found inside the page and to send the information to the signage player playback engine.
   At the player, the script is periodically executed, causing each time the retrieval of images and text items. The text is then formatted by text attributes that the center user decides to apply.
Using external software to dynamically create scripts at the player's side.
   This approach is possible with digital signage applications that are based on scripts as their general playlist common base. By this approach, scripts are used as a tool for the designer at the center to describe how would the items be created and what would they consist of. Specially designed application software executed at the player workstation can then access the script and modify it. Therefore, when the signage application software reloads the script, it may perform differently or display different information.
   The difference between the two latter approaches is rather substantial. By the first approach, a web script is used to return a list of media items (normally one item is returned at a time). The script has no impact upon the visual display of the items on screens, and is solely used to define what will be retrieved each subsequent time the script is executed. By the other approach, the script is used to define what would be displayed by the digital signage application. It deals with all aspects of the display including scheduling, rendering, visual appearance etc.
   When an external application changes the script, it simply modifies the behavior of the original script. For example, if the script has a command called Text e.g. “This is a text”, an external, specially written, program can change the script line into Text “A different text”. Then, when the digital signage system executes this script, it will display “A Different Text” instead of “This is a text”. The logic behind this text change is entirely governed by the application domain. However, if such application software needs to obtain/receive certain parameters in order to affect a change, a separate program must be created at the center in order to enable receipt of these parameters from the user.
Using different applications, such as Adobe Flash, to access dynamic data sources.
   By using these application rich visual and scripting facilities, at the control center, the user selects the appropriate Flash file, but this file should already have all the intelligence required for creating a dynamic data display.
   As will be appreciated by those skilled in the art, the abovementioned approaches require the involvement of a user/operator who should be located at the management center of the system, as he/she will have to decide which script to run, or what application software is required to change a script at a player site, or what Flash file to select, etc., and then operate them accordingly.

### SUMMARY OF THE INVENTION

It is an object of the present invention to allow the users to utilize efficiently resources of a multi player digital signage system.

It is another object of the present invention to provide means and method for integration of data derived from external sources with data being displayed at remote terminals.

It is yet another object of the present invention to provide means and method for allowing easy installation of software application in remote terminals.

Other objects of the invention will become apparent as the description of the invention proceeds.

Thus, according with a first embodiment of the present invention there is provided a computer-readable medium comprising instructions that perform a method that when executed by a processor, is operative to establish a process for display of information at least one remote terminal based on criteria established at a central terminal, wherein the method comprises:

at the central terminal (e.g. at the signage workstation):

selecting one or more sets of rules out of a plurality of pre-defined sets of rules, for displaying the information at said at least one remote terminal;

based on said selected one or more sets of rules, creating one or more virtual tokens;

forwarding the one or more virtual tokens to the at least one remote terminal;

at said at least one remote terminal:

receiving said one or more virtual tokens;

deriving from said one or more virtual tokens an identification of one or more corresponding set of rules;

based on said identified one or more set of rules, uploading one or more corresponding software modules (e.g. application(s)) operative to retrieve information originated at least one additional source for use (e.g. for being displayed, incorporated/integrated in the display, etc.) at said at least one remote terminal;

generating a display of information that comprises information retrieved by using said one or more corresponding software module; and

displaying the generated display at said at least one remote terminal.

The term “selecting one or more set of rules” as used hereinafater, should also be understood to encompass selection made by the user while creating or editing a play list item or while editing or creating a data repository item that can later be used by the user or by the application.

According to a preferred embodiment of the invention, the one or more set of rules defined at the central terminal comprises one or more items to be played at the at least one remote terminal.

Preferably, the user is allowed to select one or more pre-defined set of rules (to be referred to hereinafter also as “plug-ins”) while defining items to be comprised in the one or more play lists.

In accordance with another preferred embodiment of the invention, the process further comprises the step of extracting a corresponding one or more plug-in names from the one or more virtual tokens received at the at least one remote terminal.

The outcome of the above allows better integration of information to be displayed, with information derived from any one or more other data sources. As will be appreciated by those skilled in the art, such other data sources can be for example, a web application running on a store manager PDA, which is operative to change the signage system displayed information. In addition or in the alternative, they can be real external data sources.

By still another embodiment of the invention, the process for displaying information at the at least one remote terminal is based upon the identity of that remote terminal.

According to another aspect of the present invention there is provided in a signage system, a method for establishing a process for displaying information at least one remote terminal based on criteria established at a central terminal. The method comprises:

at the central terminal:

selecting one or more sets of rules out of a plurality of pre-defined sets of rules for displaying the information at the at least one remote terminal;

based on the selected one or more sets of rules, creating one or more virtual tokens;

forwarding the one or more virtual tokens to the at least one remote terminal;

at the at least one remote terminal:

receiving the one or more virtual tokens;

deriving from said one or more virtual tokens an identification of one or more set of rules which correspond to the one or more sets of rules selected at the central terminal;

based on the identified one or more set of rules, uploading one or more corresponding software modules operative to retrieve information originated at least one additional source for use at the at least one remote terminal;

generating a display of information that comprises information retrieved by using the one or more corresponding software applications; and

displaying the generated display at the at least one remote terminal.

By a preferred embodiment of this aspect of the invention, the one or more set of rules selected at the central terminal comprise one or more items to be played at the at least one remote terminal. For example, the plug-in may create a single item with no play-list or a list of items (a play list).

By yet another embodiment of the invention, the method provided is adapted to provide a user with an option to select one or more pre-defined set of rules for defining items to be comprised in the one or more play list of items.

In accordance with still another preferred embodiment, the method provided further comprising a step of extracting a corresponding one or more plug-in names from the one or more virtual tokens received at the at least one remote terminal.

By yet another preferred embodiment of the invention, the process for displaying information at the at least one remote terminal depends upon the identity of that remote terminal.

### BRIEF DESCRIPTION OF THE DRAWINGS

FIG. 1—presents an example of a prior art generic database access;

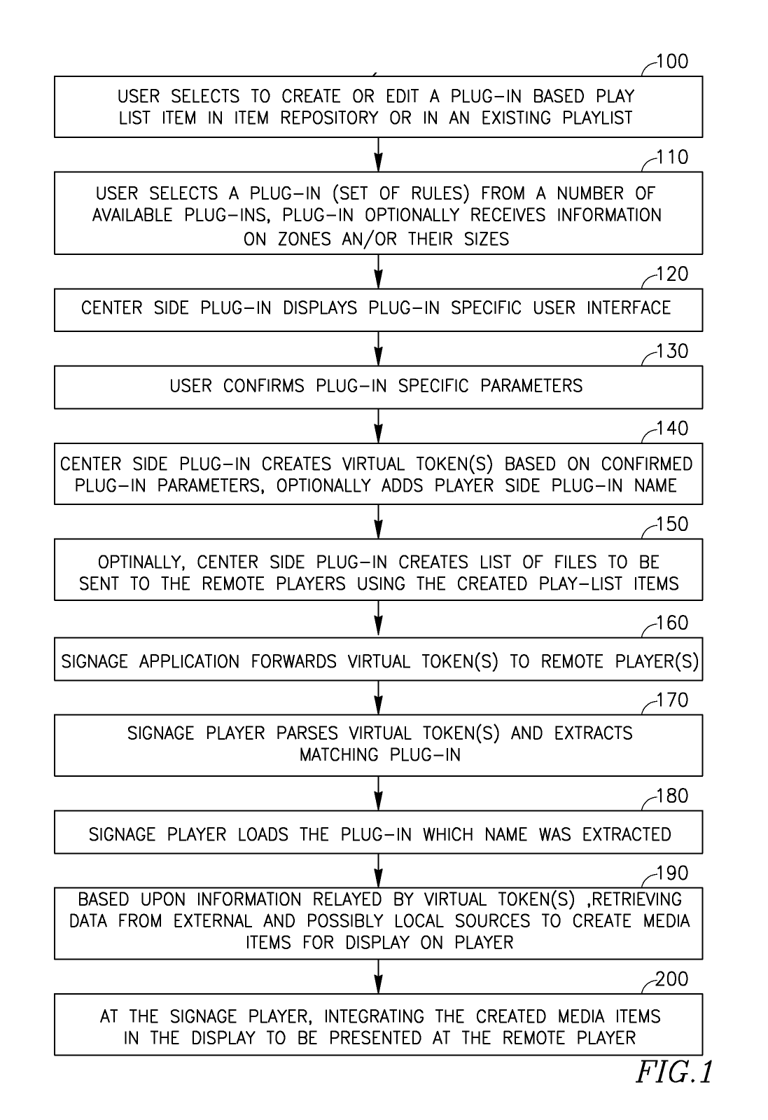

FIG. 2—presents an example of a prior art web script item dialog box;

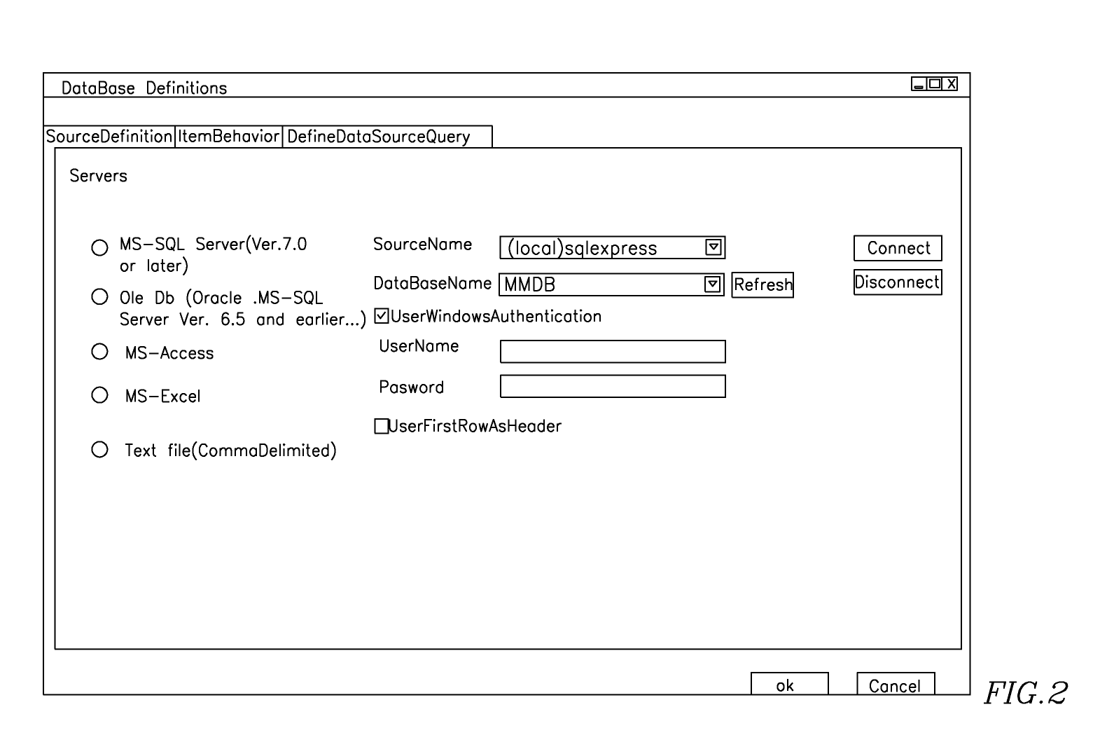

FIG. 3—presents an embodiment of the present invention enabling the user to select one of the master plug-ins;

FIG. 4—illustrates an example of selecting one of the master (central) terminal customized items;

FIG. 5—demonstrates an analog clock plug-in user interface;

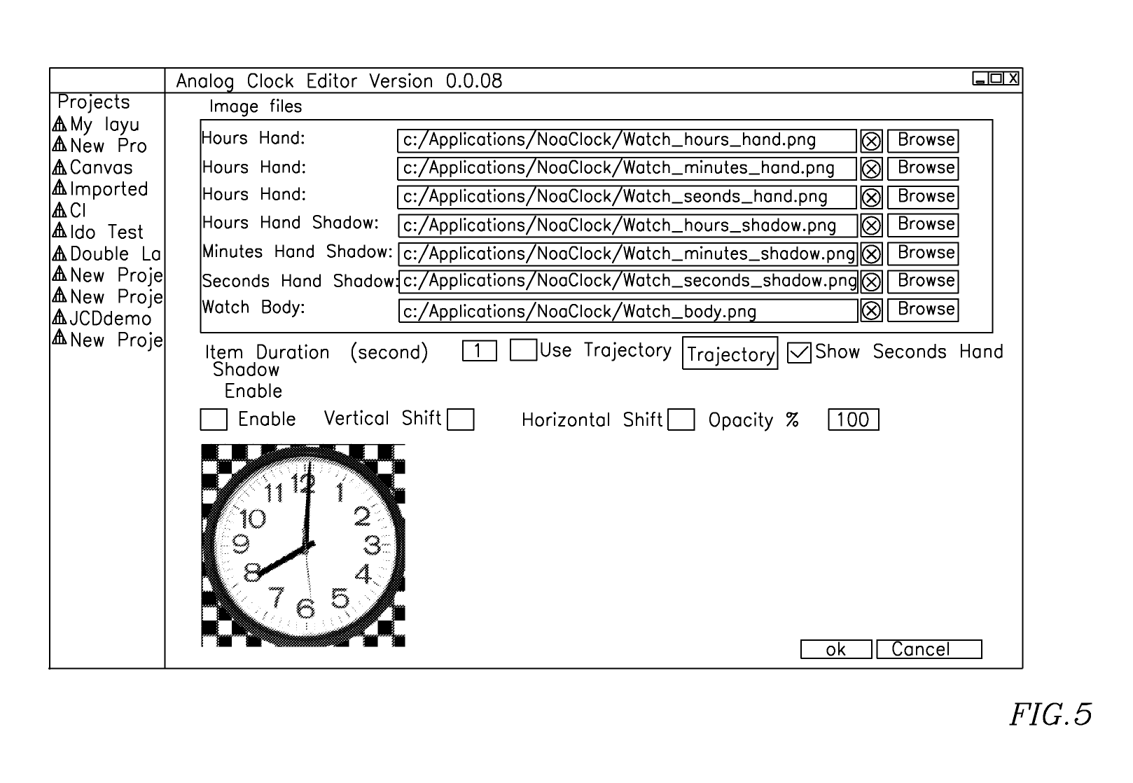

FIG. 6—presents an example of incorporating the analog clock plug-in in the display at the remote (player) terminal; and

FIGS. 7A and 7B—illustrate an example of the master side and player side plug-ins, respectively.

### DETAILED DESCRIPTION OF THE INVENTION

A better understanding of the present invention is obtained when the following non-limiting detailed description is considered in conjunction with the following drawings.

In general, a digital signage application comprises two major parts, a master station connected to a database and a player. Typically, there are many players and few master stations. By the present invention, a pair of plug-ins adapted for use in such systems and compatible with the digital signage application software, are provided, one for the center software and one for any player connected to the system.

The following is a preferred embodiment of the present invention exemplifying the use of the method provided.

In the master station, the network manager creates or edits one or more play list(s) of items to be played at the players (step 100).

Play lists can be created explicitly by the network manager or implicitly by the system, deriving from some embedded business logic in the system, assuming that the appropriate master station plug-in is stored at a special folder comprised in the digital signage application. Preferably, the plug-in would require no installation and will be recognized by the master station software upon its next restart.

The master plug-in can optionally have its own user interface and may be used for example to display information on business objects akin to the business scenario at hand. In the process of defining items for a playlist to be used in one or more remote players, the user is free to select any master plug-in that can be used in the generation of the required display at the one or more players. Item definition may be a separate task if the system supports item re-use. In such a case, items with pre-defined plug-in selection and parameters can be either used by explicit playlist creation or by available automatic playlist creation mechanism (step 110).

Once selected, the plug-in displays plug-in specific user interface (step 120). When confirmed by the user (step 130), the plug-in creates a virtual token (step 140). Optionally, the plug-in of the center creates list of files to be sent to the remote players, using the created play-list items. Also, the play list may further include the player side DLL (step 150). The token is sealed, typically would have no meaning at the level of the digital signage application, and is simply forwarded to the player(s) (step 160). The signage master application is responsible for transferring optional list of files that the plug-in requires at the players' end. The list of files may include the matching software component required to parse the token at the players' end and to execute the software.

At the player end, the virtual token is parsed and a matching plug-in name is extracted from it (step 170). This name is looked for at the player's end repository of plug-ins. If found, it would be loaded and be given with the token created at the center (step 180). Similarly to the master side, the player's digital signage application would typically have no idea as to what are the operations associated with the received token. It simply passes the token to the player's matching plug-in that has just been found. At the player side, the plug-in is responsible for parsing the token information and based on the information relayed by the virtual token(s), to retrieve respective data from an external and possibly local sources to be displayed by the player application software at one or more zones. The items created based (among others) on the retrieved data may also make use of parameters stored inside the virtual token and/or upon retrieved data (step 190). The media items are then integrated with the remaining information to be presented at the remote player (step 200), and the display would be presented in accordance with the rules controlling the operation of the remote player. When the token is handed to the plug-in software, additional information is optionally sent with it. The information may include zones information including but not limited to zones size, names and depth arrangement. The plug-in may provide the player software with media items for more then one zone. The term media item as referred to herein is used to denote all possible media items known to those skilled in the art, such as stream of frames fed at the screen refresh rate or at any other different refresh rate.

Let us now consider the following example, which demonstrates definition of an analog clock displayed on the player screen. The analog clock has two .NET dlls (Dynamically Loaded Library) one for the center and the other for the player. Both plug-ins are simply copied into the appropriate folder. The master application has the functionality which enables forwarding the players' end DLL to remote players to avoid the need to install or copy the plug-in DLL file at the players' end. Subsequently, if newer versions of the plug-in set are created, players' version can always be updated.

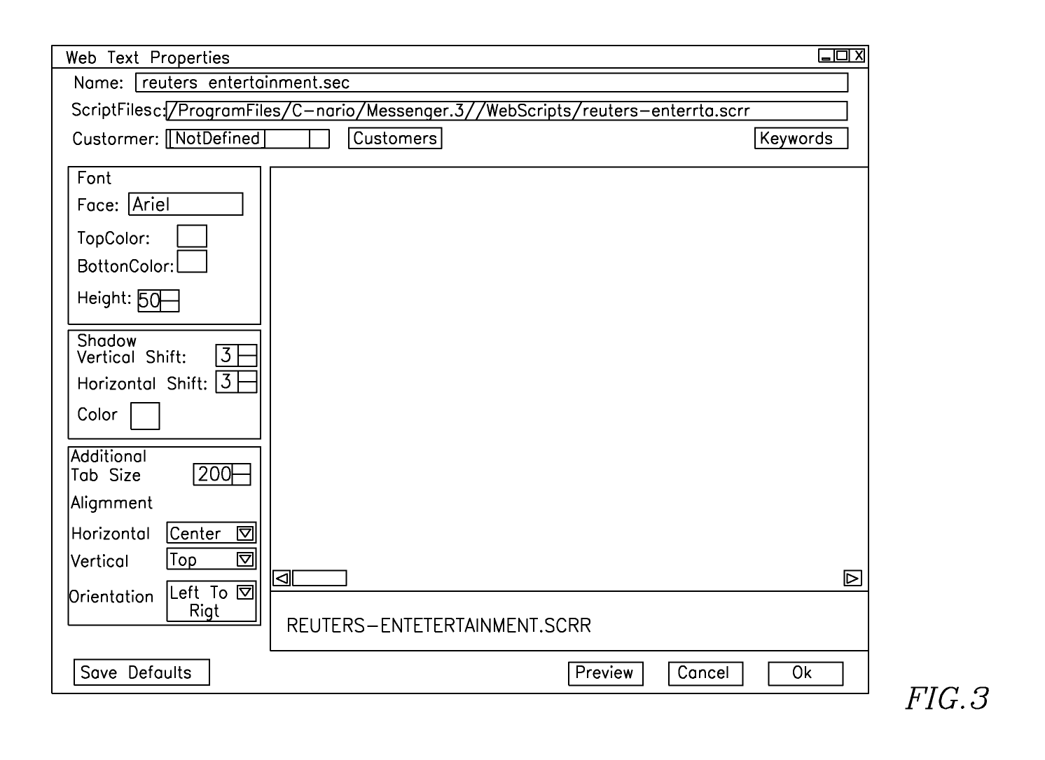

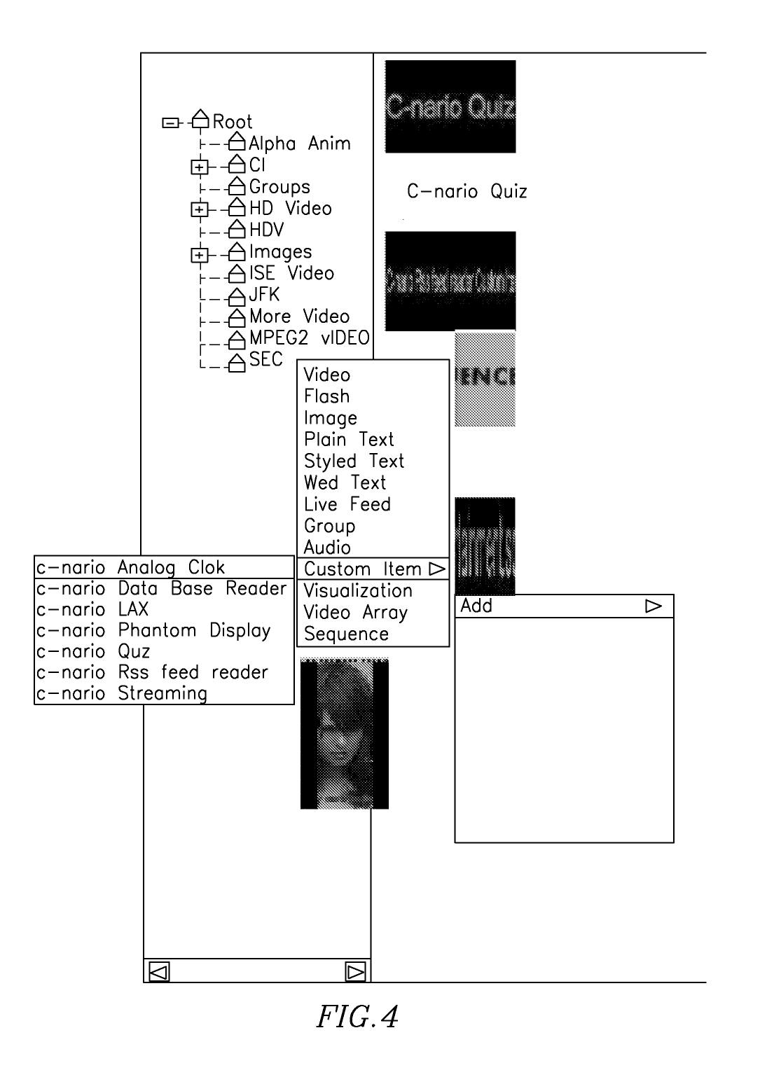

In order to create a new item inside the asset management library or directly in a play list, the user selects one of the master plug-ins, as illustrated in FIG. 3. By this example the analog clock plug-in user interface is open to allow the user to select and/or edit different parameters associated with the analog clock display. These parameters may be defined by using a dialog box shown in FIG. 4, rather then dealing with a cryptic script name or accessing a completely different application for the definition of analog clock parameters.

The user is presented with following options, preferably, associated with analog clock business environment such as:
Images for the three hands of the clock.
Images for the shadows of the clock's three hands
Image for clock body
Various parameters for transparency, duration and additional digital effects.

The above parameters have no meaning for the digital signage application. The selection of required parameters is carried out by the designer/programmer of the master plug-in, and these parameters are passed to the player matching plug-in embedded in the abovementioned token.

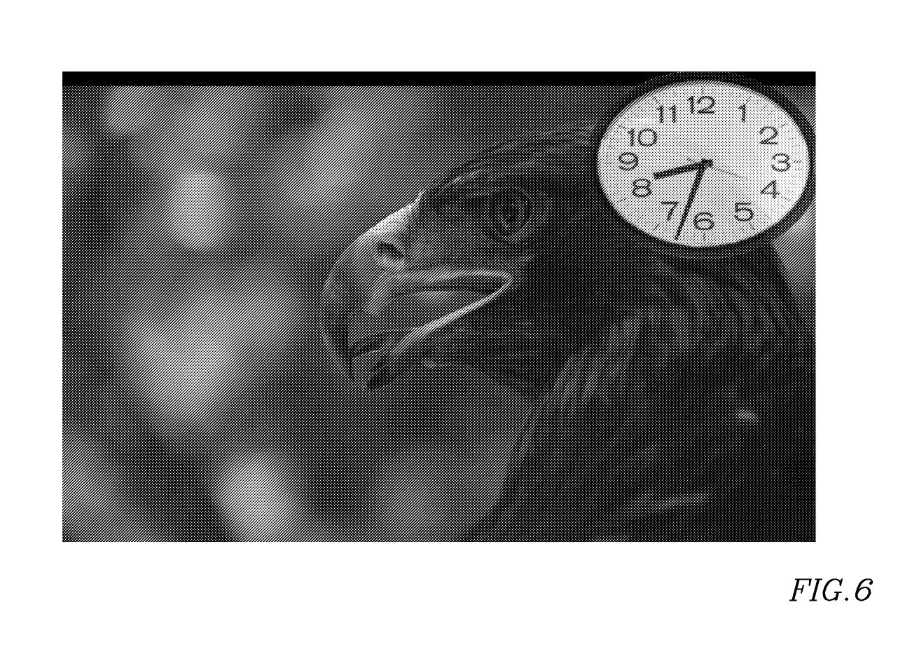

The player plug-in then parses the token parameters, and based on the information derived therefrom, creating the correct clock image every second (which was the selected item duration). An example of a resulting screen snapshot is shown in FIG. 6.

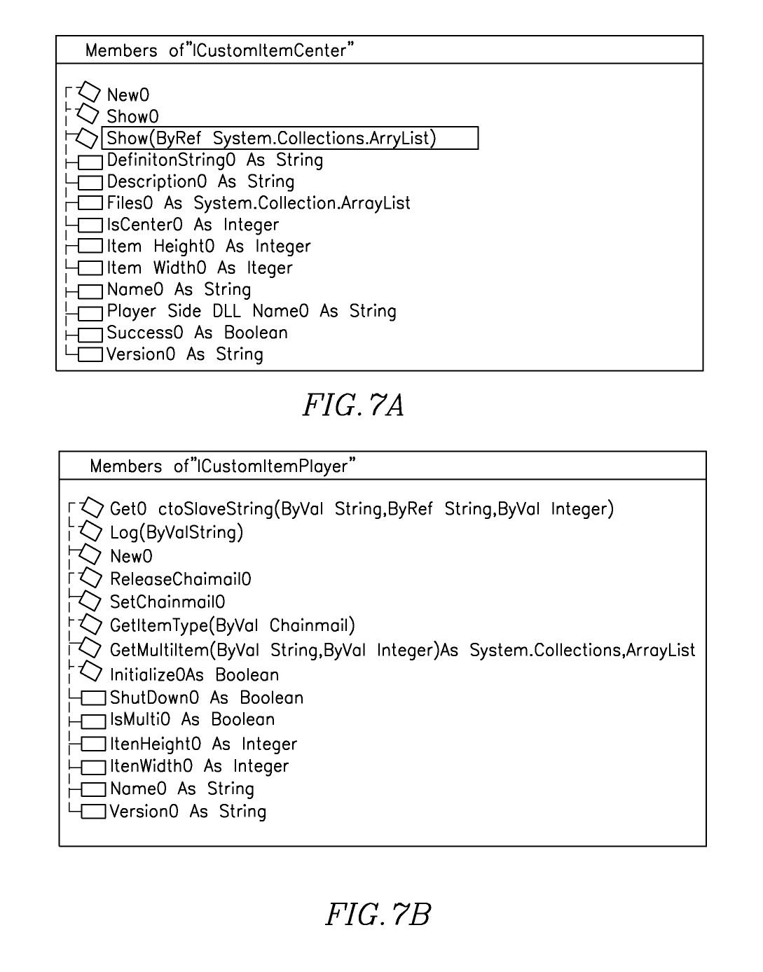

Next, FIGS. 7A and 7B illustrate an example of Implementation and programming interface for the master side plug-in members' description (7A) and for the player side (7B).

For the master side plug-in the following commands are used:
New: creates a new instance of the plug-in
Show: Displays the plug-in user interface
Show (Windows): similar to Show but passes a list of available windows in the associated layout. The list of windows is required as the plug-in may need to create items for windows other then the main window the plug-in is created for.
Definition String: this is the created token; it will be passed to players.
Description: Can be used to display information such as tool tip (outside of the Plug-in user interface) on the purpose of the plug-in.
Files: A list of files returned by the Plug-in that the signage application software needs to transfer to players, referring to the above analog example: all six image files need to be transferred.
IsCenter property: the plug-in should always return true.
Item Width and Height—provided by the signage application software, the plug-in may use it in order to render the item for preview at the center.
Name—the name of this instance of the plug-in created item.
PlayerSideDLLName—the master plug-in returns the name of the player side DLL name.

As will be appreciated by those skilled in the art, the examples provided illustrate the use of plug-ins according to the present invention to allow display of information in signage systems. However, similar methods may be applied in a similar way in order to provide such plug-ins without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A computer-readable medium comprising instructions that perform a method when executed by a processor, for establishing a process for displaying information at least one remote terminal, wherein said information is displayed based on criteria established at a central terminal, wherein the method comprises:
at the central terminal:
selecting one or more sets of rules out of a plurality of pre-defined sets of rules for displaying the information at said at least one remote terminal;
based on said selected one or more sets of rules, creating one or more virtual tokens;
forwarding the one or more virtual tokens to the at least one remote terminal;
at said at least one remote terminal:
receiving said one or more virtual tokens;
deriving from said one or more virtual tokens an identification of one or more corresponding set of rules;
based on said identified one or more set of rules, uploading one or more corresponding software modules operative to retrieve information originated at least one additional source for use at said at least one remote terminal;
generating a display of information that comprises information retrieved by using said one or more corresponding software modules; and
displaying the generated display at said at least one remote terminal.

2. A computer-readable medium according to claim 1, wherein said one or more set of rules selected at the central terminal comprise one or more items to be played at said at least one remote terminal.

3. A computer-readable medium according to claim 2, adapted to provide a user with an option to select one or more pre-defined set of rules for defining items to be comprised in said one or more play list of items.

4. A computer-readable medium according to claim 1, wherein said process for displaying information at said at least one remote terminal is based upon the identity of said remote terminal.

5. A computer-readable medium according to claim 1, wherein said method further comprises a step of extracting a corresponding one or more plug-in names from said one or more virtual tokens received at said at least one remote terminal.

6. In a signage system, a method for establishing a process for displaying information at least one remote terminal based on criteria established at a central terminal, wherein the method comprises:
at the central terminal:
selecting one or more sets of rules out of a plurality of pre-defined sets of rules for displaying the information at said at least one remote terminal;
based on said selected one or more sets of rules, creating one or more virtual tokens;
forwarding the one or more virtual tokens to the at least one remote terminal;
at said at least one remote terminal:
receiving said one or more virtual tokens;
deriving from said one or more virtual tokens an identification of one or more set of rules which correspond to the one or more sets of rules selected at said central terminal;
based on said identified one or more set of rules, uploading one or more corresponding software modules operative to retrieve information originated at least one additional source for use at said at least one remote terminal;
generating a display of information that comprises information retrieved by using said one or more corresponding software module; and
displaying the generated display at said at least one remote terminal.

7. A method according to claim 6, wherein said one or more set of rules selected at the central terminal comprise one or more items to be played at said at least one remote terminal.

8. A method according to claim 7, adapted to provide a user with an option to select one or more pre-defined set of rules for defining items to be comprised in said one or more play list of items.

9. A method according to claim 6, further comprising a step of extracting a corresponding one or more plug-in names from said one or more virtual tokens received at said at least one remote terminal.

10. A method according to claim 6, wherein said process for displaying information at said at least one remote terminal depends upon the identity of said remote terminal.
